(19) United States
(12) Patent Application Publication
(10) Pub. No.: US 2014/0220409 A1
(43) Pub. Date: Aug. 7, 2014

(54) Individual Cell for a Battery, and a Battery

(71) Applicants: Claus-Rupert Hohenthanner, Hanau (DE); Rainer Kaufmann, Stuttgart (DE); Silvio Lieb, Dresden (DE); Jens Meintschel, Bernsdorf (DE); Dirk Schroeter, Winnenden (DE); Enrico Warschefske, Haselbachtal OT Giersdorf (DE)

(72) Inventors: Claus-Rupert Hohenthanner, Hanau (DE); Rainer Kaufmann, Stuttgart (DE); Silvio Lieb, Dresden (DE); Jens Meintschel, Bernsdorf (DE); Dirk Schroeter, Winnenden (DE); Enrico Warschefske, Haselbachtal OT Giersdorf (DE)

(73) Assignee: Daimler AG, Stuttgart (DE)

(21) Appl. No.: 14/236,165

(22) PCT Filed: Jul. 18, 2012
(86) PCT No.: PCT/EP2012/003023

§ 371 Date: Apr. 4, 2014

(30) Foreign Application Priority Data
Aug. 2, 2011 (DE) 10 2011 109 203.3

(51) Int. Cl. H01M 2/26; H01M 10/04; H01M 2/02

(52) U.S. Cl. CPC H01M 2/266; H01M 2/027; H01M 10/0413
USPC 429/130

(57) ABSTRACT

A single cell for a battery includes an electrode foil stack situated in a housing formed from two enveloping metal sheets and a frame that electrically insulates the two enveloping metal sheets from one another. Current discharge tabs of electrode foils of one polarity are connected to one another to form a pole contact, and the respective pole contact is connected to an enveloping metal sheet, and an enveloping metal sheet in each case forms an electrical pole of the single cell. The current discharge tabs of the same polarity are led out in each case at a pole side of the electrode foil stack and connected to one another in a middle area of the pole side. The pole contacts are angled parallel to the pole side, in particular with respect to one-half of the particular pole side, and are connected to an enveloping metal sheet.

### BACKGROUND AND SUMMARY OF THE INVENTION

Exemplary embodiments of the present invention relate to a single cell for a battery, comprising an electrode foil stack situated in a housing formed from two enveloping metal sheets, and a frame by means of which the two enveloping metal sheets are electrically insulated from one another, current discharge tabs of electrode foils of one polarity being connected to one another to form a pole contact, and the respective pole contact being connected to an enveloping metal sheet, and an enveloping metal sheet in each case forming an electrical pole of the single cell. The invention further relates to a battery having a number of single cells.

A high-voltage battery for a vehicle, in particular an electric vehicle, a hybrid vehicle, or a vehicle operated with fuel cells, is formed from a number of single cells connected to one another in parallel and/or in series, an electronics system, and a cooling/heating system, these components being situated in a housing. In a single cell designed as a flat-frame cell, an electrode foil stack is enclosed by two planar enveloping metal sheets, or one planar and one shell-shaped enveloping metal sheet, or two shell-shaped enveloping metal sheets. The electrode foil stack is composed of anode foils and cathode foils which are electrically insulated from one another by means of a separator. The electrode foils are uncoated on at least one edge of the electrode foil stack, and protrude as current discharge tabs from the electrode foil stack, the current discharge tabs being connected to one another to form a pole contact. A pole contact is connected in each case to an inner side of the enveloping metal sheets. The enveloping metal sheets are spatially separated at a distance from one another by means of an electrically insulating frame, and form the poles of the single cell. Heat loss from charging and discharging of the single cell is conducted to a narrow side of the single cell via the appropriately thickened enveloping metal sheets, and is supplied to a heat conducting plate through which air conditioner refrigerant and/or a cooling liquid may flow. An electrically insulating thermally conductive foil is situated between the single cells and the heat conducting plate for the electrical insulation of the single cells and the metallic heat conducting plate, the enveloping metal sheets in the area of the heat conducting plate being bent down by 90° parallel to the heat conducting plate. A hot pressing process is preferably usable to close off the single cell. For this purpose, the frame is made of a thermoplastic material, at least in the area of a sealing seam.

Exemplary embodiments of the present invention are directed to a single cell for a battery which is improved over the prior art, and a battery.

A single cell for a battery comprises an electrode foil stack situated in a housing formed from two enveloping metal sheets, and a frame by means of which the two enveloping metal sheets are electrically insulated from one another, current discharge tabs of electrode foils of one polarity being connected to one another to form a pole contact, and the respective pole contact being connected to an enveloping metal sheet, and an enveloping metal sheet in each case forming an electrical pole of the single cell. According to the invention, the current discharge tabs of the same polarity are led out in each case at a pole side of the electrode foil stack and connected to one another in a middle area of the pole side to form a pole contact, the pole contacts being connected parallel to the pole side, in particular being angled with respect to one-half of the pole side, and being connected to an enveloping metal sheet.

The middle area of the pole side from which the current discharge tabs are led out should be understood to mean the plane of the electrode foil stack, which is situated approximately centrally in the electrode foil stack.

As a result of the pole contacts being angled parallel to the pole side of the electrode foil stack, the enveloping metal sheets may be smaller with regard to their dimensions, in particular their longitudinal extent, so that advantageously, less installation space is necessary for situating the single cell. In addition, a reduction in the longitudinal extent of the enveloping metal sheets results in material savings, so that the single cell can be manufactured at a comparatively lower cost and has a lower weight.

In addition, by angling of the pole contacts, contacting these with the particular enveloping metal sheet may be carried out with smaller installation space requirements.

The enveloping metal sheets preferably have a shell-shaped design, and in each case a pole contact is connected to an end-face side wall of an enveloping metal sheet. The pole side of the electrode foil stack is particularly advantageously situated in the direction of the end-face side wall of the shell-shaped enveloping metal sheet. Due to the connection of the pole contact to the enveloping metal sheet, the particular enveloping metal sheet conducts voltage, and thus represents an electrical pole of the single cell.

To ensure long-lasting contacting between the particular pole contact and the end face of the shell-shaped enveloping metal sheet, the pole contact is fastened to the end-face side wall of the particular enveloping metal sheet at least in an integrally bonded manner. An ultrasonic welding process in particular is suited for establishing the integrally bonded connection.

In an alternative embodiment, the enveloping metal sheets have a planar design, and the particular pole contact of the electrode foil stack is connected to the enveloping metal sheet by means of an electrically conductive contacting element. Due to the planar design of the enveloping metal sheets, the complexity of manufacturing the enveloping metal sheets is reduced in comparison to the shell-shaped embodiment, thus allowing a reduction of costs and expenditure of time in manufacturing the single cell. A contacting element is situated on each pole side of the electrode foil stack in order to establish an electrical connection between the pole contact and the enveloping metal sheet, so that the particular enveloping metal sheet conducts voltage during operation of the single cell.

The contacting element is preferably joined to the enveloping metal sheet at least in an integrally bonded manner, here as well the ultrasonic welding process being suitable for this purpose. The joining of the contacting elements to the particular enveloping metal sheet is particularly preferably designed in such a way that the contacting between the pole contacts of the electrode foil stack and the enveloping metal sheets by means of the contacting element remains over the entire service life of the single cell.

In one advantageous embodiment, the contacting element is a metal plate that is situated between the pole contact and the enveloping metal sheet and, as described above, which is joined at least to the enveloping metal sheet in an integrally bonded manner. The metal plate is made of a metal having very good electrical conductivity and also has heat resistance, since the single cell generates lost heat during charging and discharging, i.e., during operation.

To be able to implement the contacting between the particular enveloping metal sheet and the particular pole contact of the electrode foil stack in a way that optimizes installation space, the metal plate is preferably angled, and thus has two legs. One leg is preferably connected to the pole contact, and the other leg is preferably connected to the enveloping metal sheet. In particular, the legs of the metal plate are angled by 90° with respect to one another, so that the particular pole contact, under the aspect of optimizing the installation space, lies flat against the one leg, and the other leg is connected to the enveloping metal sheet with the largest possible surface area.

In one preferred embodiment of the single cell, the particular pole contact is fastened at least in an integrally bonded manner to the one leg of the particular metal plate as a contacting element.

Furthermore, for forming the housing of the single cell, one enveloping metal sheet is shell-shaped and the other enveloping metal sheet is planar, the pole contact associated with the shell-shaped enveloping metal sheet being connected to the end-face side wall of the enveloping metal sheet, and the pole contact associated with the planar enveloping metal sheet being connected to the enveloping metal sheet by means of the contacting element, in particular in the form of the angled metal plate.

The invention further relates to a battery having a number of single cells designed according to the preceding description. As a result of the pole contacts being situated in the middle area of the particular pole side of the electrode foil stack and angled parallel to the pole side, the dimensions of the battery may also be decreased, thus reducing installation space requirements for situating the battery and likewise reducing the weight of the battery.

The battery is preferably a vehicle battery, in particular a traction battery of an electric vehicle, a hybrid vehicle, or a vehicle operated with fuel cells.

As a result of the possibility for reducing the size of single cells, and thus reducing a vehicle battery installation space formed by the single cells, as described above, an installation space in a vehicle for situating the battery as the vehicle battery may also be reduced. In addition, the weight of the vehicle battery as well as the overall weight of the vehicle may also be reduced in this way.

### BRIEF DESCRIPTION OF THE DRAWING FIGURES

Exemplary embodiments of the invention are explained in greater detail below with reference to the drawings, which show the following:

FIG. 1 schematically shows a single cell having planar enveloping metal sheets for forming a housing, in an exploded illustration according to the prior art,

FIG. 2 schematically shows a perspective view of the single cell having the planar enveloping metal sheets, in the assembled state,

FIG. 3 schematically shows the single cell having the planar enveloping metal sheets, in a sectional illustration,

FIG. 4 schematically shows a single cell having shell-shaped enveloping metal sheets, in an exploded illustration according to the prior art,

FIG. 5 schematically shows the single cell having the shell-shaped enveloping metal sheets, in a sectional illustration,

FIG. 6 schematically shows a first embodiment of a single cell according to the invention having shell-shaped enveloping metal sheets, in an exploded illustration,

FIG. 7 schematically shows a perspective view of the single cell according to FIG. 6, in the assembled state,

FIG. 8 schematically shows a sectional illustration of the single cell,

FIG. 9 schematically shows a sectional illustration of an enlarged detail of the single cell,

FIG. 10 schematically shows a perspective view of the single cell with the enveloping metal sheets folded out,

FIG. 11 schematically shows a sectional illustration of the single cell with folded-out enveloping metal sheets in one manufacturing step,

FIG. 12 schematically shows a second embodiment of the single cell according to the invention having planar enveloping metal sheets and a contacting element, in an exploded illustration,

FIG. 13 schematically shows a sectional illustration of the single cell, and

FIG. 14 schematically shows a sectional illustration of an enlarged detail of the single cell.

Mutually corresponding parts are provided with the same reference numerals in all figures.

### DETAILED DESCRIPTION

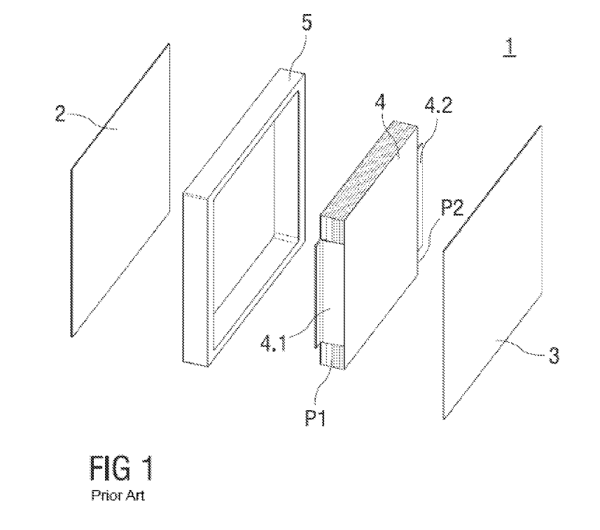

The single cells 1 illustrated in each of FIGS. 1 through 14 are a component of a battery, in particular a vehicle battery in the form of a traction battery for an electric vehicle, a hybrid vehicle, or a vehicle operated with fuel cells.

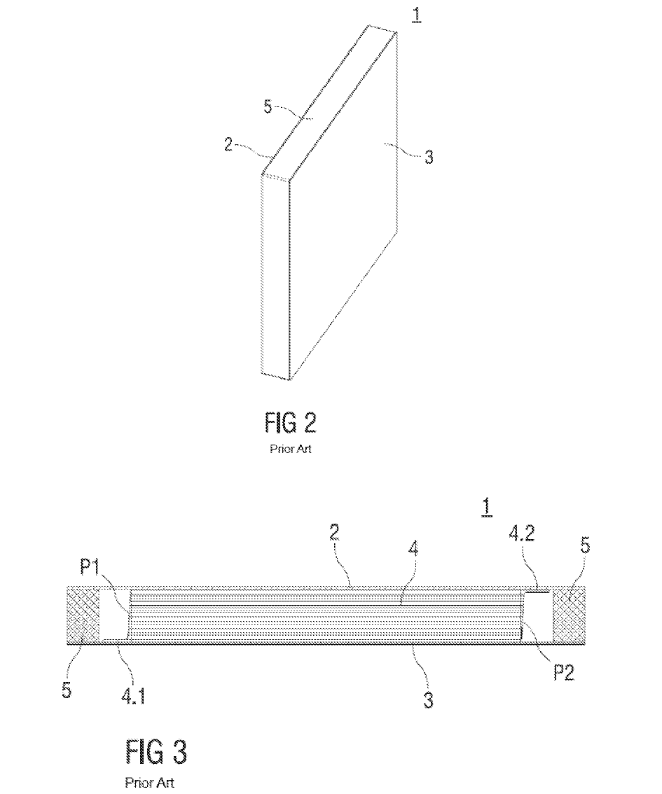

FIGS. 1 through 3 show a single cell 1 according to the prior art, having two planar enveloping metal sheets 2, 3 for forming a housing, FIG. 1 showing an exploded illustration of the single cell 1, FIG. 2 showing the single cell 1 in the assembled state, and FIG. 3 showing a longitudinal section of the single cell 1.

The single cell 1 according to the prior art has an electrode foil stack 4, a frame 5, and the two planar enveloping metal sheets 2, 3.

The electrode foil stack 4 is formed from individual electrode foils, preferably coated copper foils and coated aluminum foils, a separator foil for spatially separating the electrode foils of different polarities being situated in each case between the copper foils and the aluminum foils. A separator foil is situated on both sides of the electrode foil stack 4 and closes off same, so that the electrode foil stack 4 is separated and thus electrically insulated with respect to the enveloping metal sheets 2, 3.

A section of the electrode foils is led out, uncoated, from the electrode foil stack 4 at each pole side P1, P2 of the electrode foil stack 4, this protruding area of an electrode foil being referred to as a current discharge tab.

The current discharge tabs are led out centrally, in relation to a longitudinal extent of the pole side P1, P2, from the electrode foil stack 4.

For forming a pole contact 4.1, 4.2, the current discharge tabs of the electrode foils having one polarity are connected to one another; i.e., the current discharge tabs are tacked together. In addition, for forming an electrical pole of the single cell 1, in each case a pole contact 4.1, 4.2 of a pole side P1, P2, respectively, of the electrode foil stack 4 is connected to an inner side of the respective enveloping metal sheet 2, 3. For this purpose, during production of the single cell 1 the pole contacts 4.1, 4.2 are fastened to the particular enveloping metal sheet 2, 3 in a pressing process and/or fusion welding process, for example resistance spot welding, ultrasonic welding, or laser welding.

Additionally or alternatively, it is conceivable for the particular pole contact 4.1, 4.2 to be fastened to the corresponding enveloping metal sheet 2, 3 in a force-fit manner, for example by riveting.

To spatially separate and thus electrically insulate the two enveloping metal sheets 2, 3 from one another, which as electrical poles of the single cell 1 conduct voltage during operation of same, the frame 5 is situated between the two enveloping metal sheets 2, 3 so as to enclose the electrode foil stack 4 at the edges. The frame 5 is preferably formed, at least in part, from a thermoplastic material, so that the frame 5 is connectable on both sides to the enveloping metal sheets 2, 3 preferably in a hot pressing process.

In the assembled state the single cell 1 has a cuboidal shape, as illustrated in greater detail in FIGS. 2 and 3.

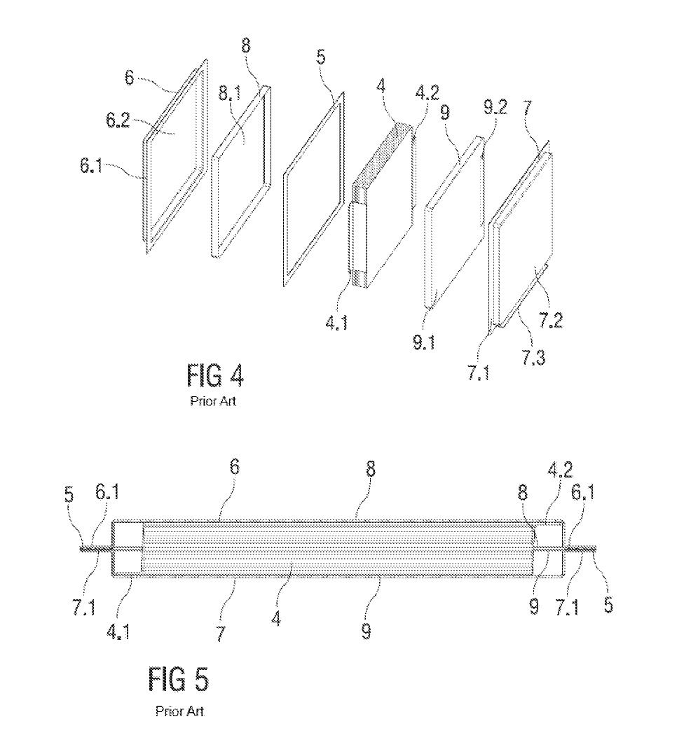

Another embodiment of the single cell 1 according to the prior art is shown in FIGS. 4 and 5, shell-shaped enveloping metal sheets 6, 7 being provided for forming the housing.

In this embodiment, the single cell 1 additionally has two insulating shells 8, 9 in which the electrode foil stack 4 is situated in the assembled state of the single cell 1. The electrode foil stack 4 is electrically insulated from the shell-shaped enveloping metal sheets 6, 7 by means of the insulating shells 8, 9, respectively, for this purpose the insulating shells 8, 9 being made of an electrically nonconductive material, or at least coated with an electrically nonconductive material. In addition, the shell-shaped enveloping metal sheets 6, 7 are electrically insulated from one another by means of the insulating shells 8, 9, respectively.

On their largest side 8.1, 9.1 with regard to area, the insulating shells 8, 9 each have a rectangular cutout 9.2 through which in each case a pole contact 4.1, 4.2 of the electrode foil stack 4 may be led during assembly of the single cell 1. If the electrode foil stack 4 is situated in the insulating shells 8, 9, and the pole contacts 4.1, 4.2 are led through the cutouts 9.2, the module thus formed is situated in one of the shell-shaped enveloping metal sheets 6, 7. A pole contact 4.1, 4.2 of the electrode foil stack 4 lies against the inner side of the shell-shaped enveloping metal sheet 6, 7, and is preferably connected thereto at least in an integrally bonded manner.

The shell-shaped enveloping metal sheets 6, 7 for forming the housing are angled in their edge areas, so that the shell-shaped enveloping metal sheet 6, 7 has an edge 6.1, 7.1, respectively, extending parallel to its largest side 6.2, 7.2, respectively, with regard to area.

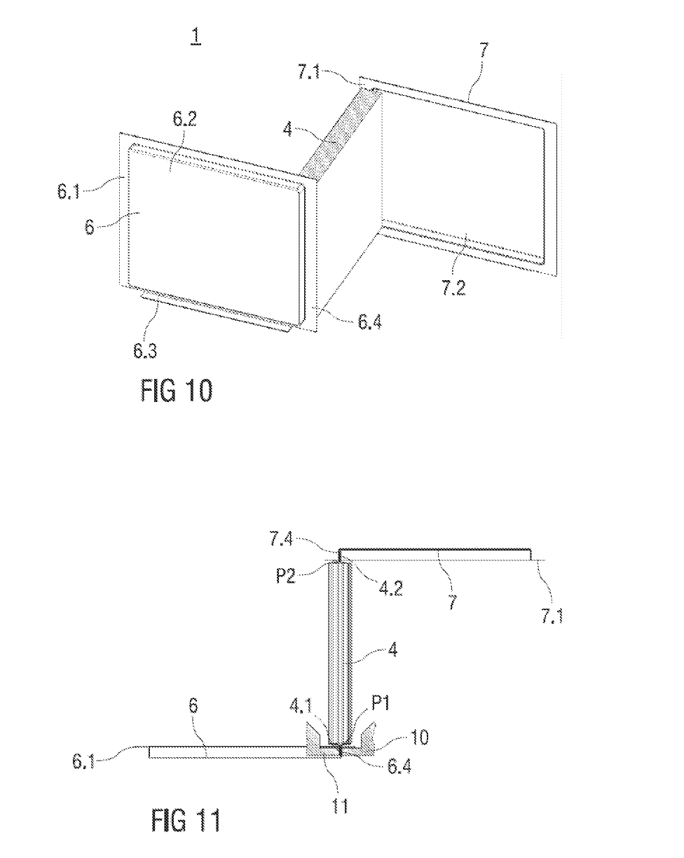

In addition, protruding bends 6.3, 7.3 are formed or molded on, perpendicular to the edge 6.1, 7.1, at the edge 6.1, 7.1 of the shell-shaped enveloping metal sheet 6, 7, respectively, corresponding to the longitudinal extent of the electrode foil stack 4 and corresponding to the longitudinal extent of the shell-shaped enveloping metal sheets 6, 7, the bend 6.3 of the first shell-shaped enveloping metal sheet 6 being shown in FIG. 10.

The bends 6.3, 7.3 in the shell-shaped enveloping metal sheets 6, 7, respectively, are used for improved dissipation of lost heat generated in the single cell 1 during charging and discharging, wherein the lost heat may be supplied to the heat conducting plate, which is part of the battery.

The frame 5, which is used for electrically insulating the shell-shaped enveloping metal sheets 6, 7 from one another and for closing off the single cell 1, carried out by means of the hot pressing process, for example, is situated between these edges 6.1, 7.1 of the shell-shaped enveloping metal sheets 6, 7, respectively.

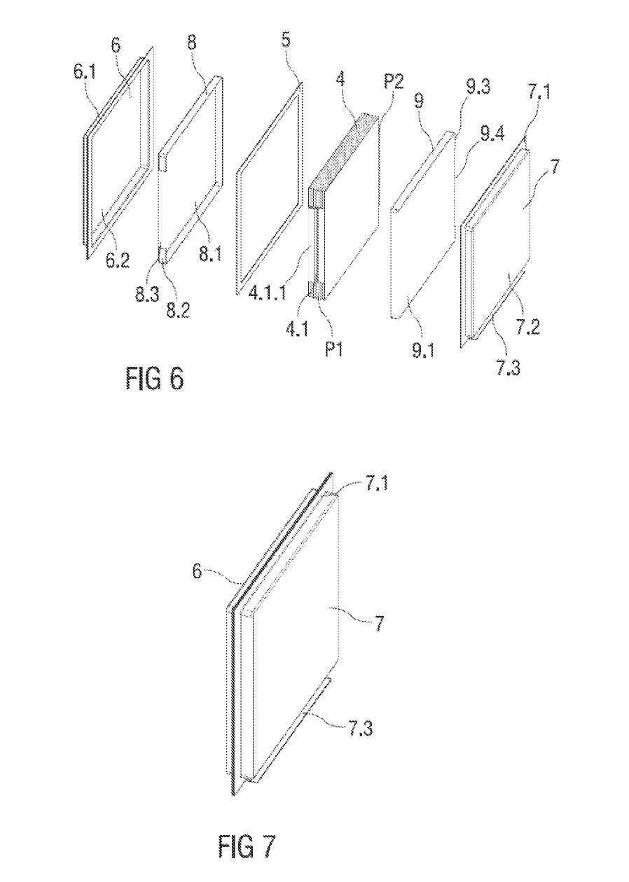

FIG. 6 shows an exploded illustration of a first embodiment according to the invention of a single cell 1.

The single cell 1 has two shell-shaped enveloping metal sheets 6, 7, two insulating shells 8, 9, the frame 5, and the electrode foil stack 4.

To optimally design the single cell 1 installation space and achieve contacting of the pole contacts 4.1, 4.2 with the shell-shaped enveloping metal sheets 6, 7 with comparatively small installation space requirements, in accordance with the invention the current discharge tabs of the electrode foils of one polarity are led out centrally from the electrode foil stack 4 with regard to the width of the particular pole side P1, P2, and are angled parallel to the side P1, P2, in particular with respect to one-half of the respective pole side P1, P2.

The angled section 4.1.1, 4.2.1 of the pole contact 4.1, 4.2, respectively, for the electrical insulation has a predefinable distance from the corresponding pole side P1, P2, respectively, of the electrode foil stack 4.

For forming an electrical pole of the single cell 1, the particular angled section 4.1.1, 4.2.1 is connected to a shell-shaped enveloping metal sheet 6, 7, for this purpose the pole contacts 4.1, 4.2 of the electrode foil stack 4 being angled in opposite directions.

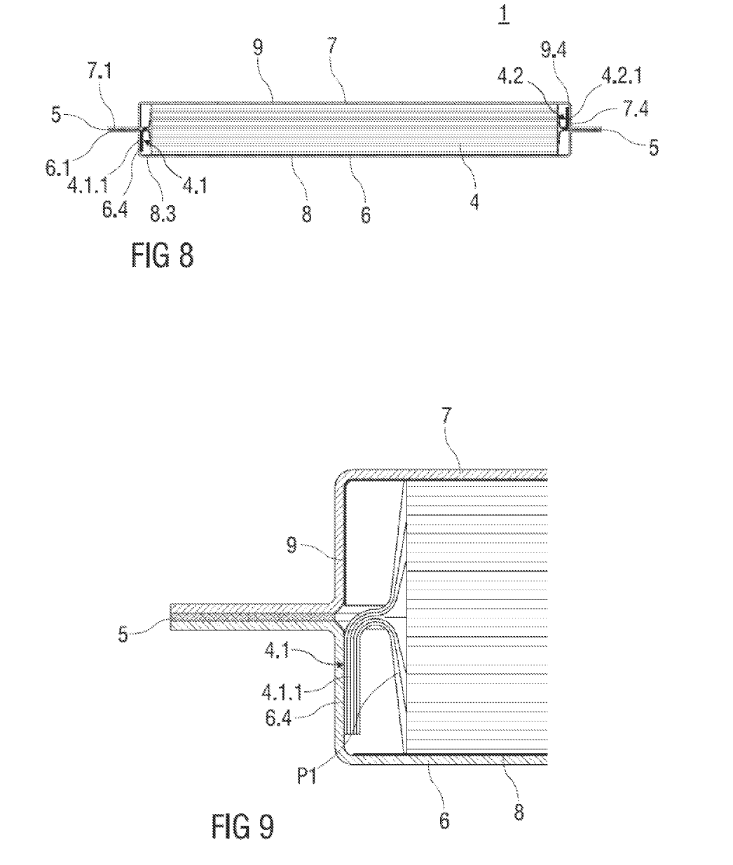

In other words, a tip of the one angled section 4.1.1 is situated in the direction of the one shell-shaped enveloping metal sheet 6, and a tip of the other angled section 4.2.1 is situated in the direction of the other shell-shaped enveloping metal sheet 7, as shown in greater detail in FIG. 8.

For contacting the pole contacts 4.1, 4.2 with an end-face side wall 6.4, 7.4, respectively, of the respective shell-shaped enveloping metal sheet 6, 7, the insulating shells 8, 9 have a material recess 8.3, 9.4, respectively, at an end-face side wall 8.2, 9.3 associated with the corresponding pole contact 4.1, 4.2.

The dimensions of the material recesses 8.3, 9.4 are selected to be greater than at least the length of the angled section 4.1.1, 4.2.1 of the pole contacts 4.1, 4.2, respectively, as illustrated in greater detail in FIGS. 8 and 9.

FIG. 7 illustrates the single cell 1 in the assembled state, in the assembled state there being essentially no external difference of the single cell 1 according to the invention from the single cell 1 illustrated in FIGS. 4 and 5.

FIGS. 8 and 9 show the single cell 1 in its first embodiment, in each case in a longitudinal section, FIG. 9 illustrating an enlarged detail of a pole side P1 of the electrode foil stack 4 together with an angled pole contact 4.1.

The angled section 4.1.1 is connected to the end-face side wall 6.4 of the first shell-shaped enveloping metal sheet 6, the pole contact 4.1 being angled in the direction of this end-face side wall 6.4.

To establish a long-lasting connection, and thus the electrical contacting between the pole contacts 4.1, 4.2 and the corresponding shell-shaped enveloping metal sheets 6, 7, respectively, the particular angled section 4.1.1, 4.2.1 is preferably fastened to the respective end-face side wall 6.4, 7.4 of the shell-shaped enveloping metal sheet 6, 7, respectively, by means of an ultrasonic welding process.

The angled section 4.1.1, 4.2.1 of the respective pole contact 4.1, 4.2 lies with its largest possible surface area against the end-face side wall 6.4, 7.4 of the corresponding shell-shaped enveloping metal sheet 6, 7, as the result of which the electrical contacting is established and the respective enveloping metal sheet 6, 7 conducts voltage during operation of the single cell 1.

FIG. 10 shows the single cell 1 in the folded-out state of the shell-shaped enveloping metal sheets 6, 7 in order to connect the pole contact 4.1, 4.2 to the corresponding end-face side wall 6.4, 7.4 of the enveloping metal sheet 6, 7, respectively, as shown in greater detail in a sectional illustration in FIG. 11.

During production of the single cell 1, i.e., connection of the pole contacts 4.1, 4.2 to the end-face side wall 6.4, 7.4, respectively, the electrode foil stack 4 is oriented with respect to the two shell-shaped enveloping metal sheets 6, 7 in such a way that the pole contacts 4.1, 4.2, which are not yet angled, lie flat against their associated end-face side wall 6.4, 7.4.

The longitudinal extent of the electrode foil stack 4 is situated perpendicularly with respect to the longitudinal extent of one of the shell-shaped enveloping metal sheets 6, 7, thus providing access on both sides of the end-face side wall 6.4, 7.4 for components of a fastening tool. The shell-shaped enveloping metal sheet 6 is situated on a stationary anvil 10 at an outer side of the end-face side wall 6.4 at which the pole contact 4.1 is to be fastened, the pole contact 4.1, which is not yet angled, being welded to the end-face side wall 6.4 by means of a moving sonotrode 11.

The same method step is carried out with the further pole contact 4.2 and the corresponding end-face side wall 7.4 of the remaining shell-shaped enveloping metal sheet 7, so that the two pole contacts 4.1, 4.2 are fastened to the shell-shaped enveloping metal sheets 6, 7, respectively, at least in an integrally bonded manner.

The free end of the particular shell-shaped enveloping metal sheet 6, 7 is subsequently swiveled in the direction of the electrode foil stack 4, thus bending the pole contacts 4.1, 4.2 by 90° in relation to their starting position, so that the angled section 4.1.1, 4.2.1 is situated parallel to the pole side P1, P2, respectively.

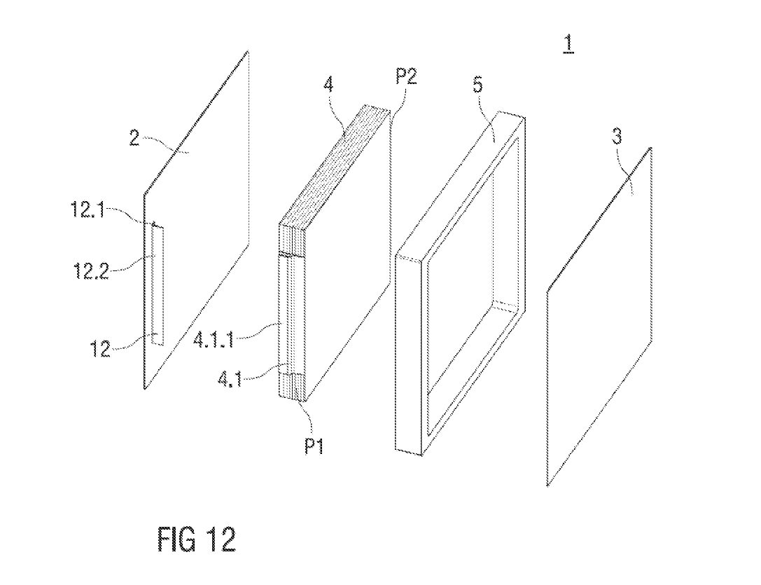

FIGS. 12 through 14 illustrate a second embodiment of the single cell according to the invention 1 in a perspective view.

In this embodiment, as shown in FIGS. 1 through 3, the enveloping metal sheets 2, 3, are planar, i.e., flat and not shell-shaped.

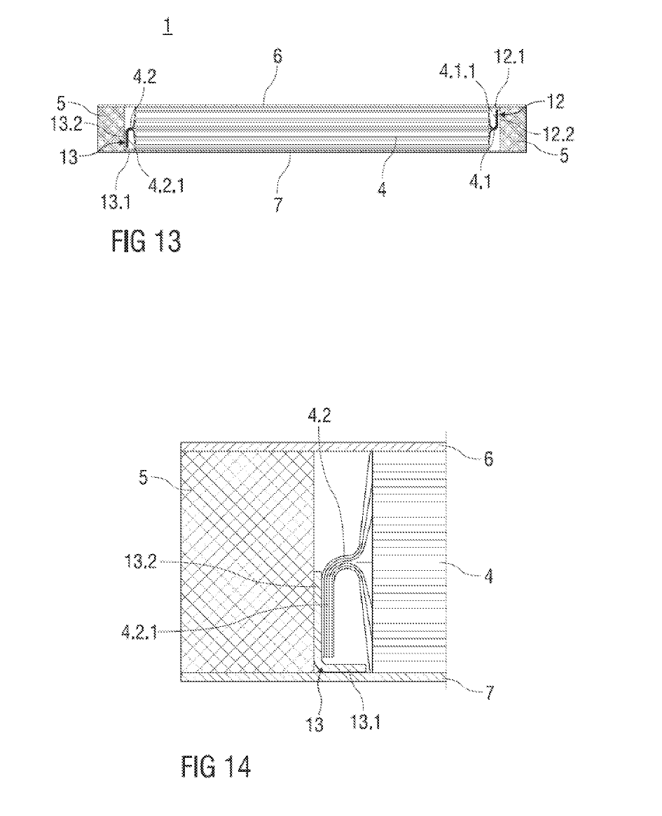

For contacting the pole contact 4.1, 4.2 with the corresponding enveloping metal sheet 2, 3, a contacting element 12, 13 is provided in the form of an angled metal plate having a comparatively high electrical conductivity. As a result of the contacting elements 12, 13 being angled, they each have two legs 12.1, 12.2 and 13.1, 13.2, respectively, a first leg 12.1, 13.1 being connected to the enveloping metal sheet 2, 3, respectively, and a second leg 12.2, 13.2 being connected to the pole contact 4.1, 4.2, respectively, as shown in detail in FIGS. 13 and 14.

To connect the pole contact 4.1, 4.2 to the contacting element 12, 13, respectively, and to the corresponding enveloping metal sheet 2, 3, respectively, via the respective contacting element 12, 13, it may be provided that initially the first leg 12.1, 13.1 is fastened to the enveloping metal sheet 2, 3, respectively, by ultrasonic welding.

The particular pole contact 4.1, 4.2 of the electrode foil stack 4 is not yet angled, and is situated on a surface of the second leg 12.2, 13.2 associated with the pole contact 4.1, 4.2, respectively, perpendicularly with respect to the longitudinal extent of the enveloping metal sheet 2, 3, respectively, and thus also perpendicularly with respect to the first leg 12.1, 13.1, respectively, of the corresponding contacting element 12, 13. The pole contact 4.1, 4.2 is subsequently fastened to the second leg 12.2, 13.2, respectively, by ultrasonic welding.

The enveloping metal sheets 2, 3, which are fastened to the pole contacts 4.1, 4.2, respectively, by means of the contacting elements 12, 13, respectively, are subsequently swiveled in the direction of the electrode foil stack 4, so that the pole contacts 4.1, 4.2 are bent by 90° in relation of their starting position, and are thus parallel to the respective pole side P1, P2.

The second leg 12.2, 13.2 of the contacting element 12, 13, respectively, lies with its side facing away from the pole contact 4.1, 4.2 against the frame 5, within which the electrode foil stack 4 is situated.

The angled section 4.1.1, 4.2.1 of the pole contact 4.1, 4.2, respectively, is connected to the corresponding enveloping metal sheet 2, 3 by means of the contacting element 12, 13, respectively, so that the enveloping metal sheets 2, 3 conduct voltage during operation of the single cell 1.

Contacting of the pole contacts 4.1, 4.2 with the enveloping metal sheet 2, 3, respectively, which reduces the installation space is achievable by means of the contacting elements 12, 13, respectively.

In a possible third embodiment, for forming the housing the single cell 1 has a shell-shaped enveloping metal sheet 6, 7 as well as a planar enveloping metal sheet 2, 3, the contacting of the pole contacts 4.1, 4.2 with the respective enveloping metal sheets 2, 3 and 6, 7 taking place as explained in greater detail above.

The electrode foil stack 4 may be formed by means of individual electrode foils and separator foils which are stacked one on top of the other.

Alternatively, for this purpose bands may be formed from the electrode foils of different polarities and the separator foils, and wound, in particular flatly wound, or the separator foils may be folded in a z shape and the electrode foils laterally inserted, in alternation with regard to the polarity, into the pockets in the separator foil thus formed.

As a result of the pole contacts 4.1, 4.2 of the electrode foil stack 4 being angled in comparison to the prior art, the dimensions of the enveloping metal sheets 2, 3, 6, 7 may be reduced, in particular with regard to their longitudinal extent. The single cell 1 is thus reducible, at least with regard to its longitudinal extent, so that material usage in the manufacture of the enveloping metal sheets 2, 3, 6, 7 may be decreased. In addition, weight savings of the single cell 1 are achievable due to the decreased material usage.

If the single cell 1 is a component of a battery, in particular a vehicle battery, which contains a predefinable number of single cells 1 of this type of design, the battery i.e., a battery housing corresponding to the dimensions of the single cells 1, may be reduced in size, thus decreasing installation space requirements for situating the battery and likewise reducing the weight of the battery.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS/CHARACTERS

1 Single cell
2 Enveloping metal sheet
3 Enveloping metal sheet
4 Electrode foil stack
4.1 Pole contact
4.2 Pole contact
5 Frame
6 First shell-shaped enveloping metal sheet
6.1 Edge
6.2 Largest side with regard to area
6.3 Bend
6.4 End-face side wall
7 Second shell-shaped enveloping metal sheet
7.1 Edge
7.2 Largest side with regard to area
7.3 Bend
7.4 End-face side wall
8 Insulating shell
8.1 Largest side with regard to area
8.2 End-face side wall
8.3 Material recess
9 Insulating shell
9.1 Largest side with regard to area
9.2 Cutout
9.3 End-face side wall
9.4 Material recess
10 Anvil
11 Sonotrode
12 Contacting element
12.1 First leg
12.2 Second leg
13 Contacting element
13.1 First leg
13.2 Second leg
P1 Pole side
P2 Pole side

1-10. (canceled)

11. A single cell for a battery, comprising:
an electrode foil stack comprising a plurality of electrode foils and situated in a housing formed from first and second enveloping metal sheets; and
a frame configured to electrically insulate the first and second enveloping metal sheets from one another,
wherein current discharge tabs of the plurality of electrode foils of a first polarity are connected to one another to form a first pole contact,
wherein current discharge tabs of the plurality of electrode foils of a second polarity are connected to one another to form a second pole contact,
wherein the first pole contact is connected to the first enveloping metal sheet, which forms a first electrical pole of the single cell,
wherein the second pole contact is connected to the second enveloping metal sheet, which forms a second electrical pole of the single cell,
wherein the current discharge tabs of the first polarity are led out at a first pole side of the electrode foil stack and are connected to one another in a middle area of the first pole side to form the first electrical pole contact, and the first electrical pole contact is angled parallel to the first pole side and is connected to the first enveloping metal sheet, and
wherein the current discharge tabs of the second polarity are led out at a second pole side of the electrode foil stack and are connected to one another in a middle area of the second pole side to form the second electrical pole contact, and the second electrical pole contact is angled parallel to the second pole side and is connected to the second enveloping metal sheet.

12. The single cell according to claim 11, wherein the first and second enveloping metal sheets have a shell-shaped design, the first pole contact is connected to an end-face side wall of the first enveloping metal sheet, and the second pole contact is connected to an end-face side wall of the second enveloping metal sheet.

13. The single cell according to claim 12, wherein the first and second pole contacts are respectively fastened to the ends-face side walls of the first and second enveloping metal sheets in at least an integrally bonded manner.

14. The single cell according to claim 11, wherein the first and second enveloping metal sheets have a planar design, the first pole contact is connected to the first enveloping metal sheet by a first electrically conductive contacting element, and the second pole contact is connected to the second enveloping metal sheet by a second electrically conductive contacting element.

15. The single cell according to claim 14, wherein the first and second pole contacts are respectively connected to the first and second enveloping metal sheets in at least an integrally bonded manner.

16. The single cell according to claim 14, wherein the first and second electrically conductive contacting elements are respectively first and second metal plates.

17. The single cell according to claim 16, wherein the first metal plate is angled and has one leg connected to the first pole contact and another leg connected to the first enveloping metal sheet, and wherein the second metal plate is angled and has one leg connected to the second pole contact and another leg connected to the second enveloping metal sheet.

18. The single cell according to claim 17, wherein the first and second pole contacts are respectively fastened to the one leg of the first and second metal plates at least in an integrally bonded manner.

19. A battery having a plurality of single cells, each single cell comprising:
comprising:
an electrode foil stack comprising a plurality of electrode foils and situated in a housing formed from first and second enveloping metal sheets; and
a frame configured to electrically insulate the first and second enveloping metal sheets from one another,
wherein current discharge tabs of the plurality of electrode foils of a first polarity are connected to one another to form a first pole contact,
wherein current discharge tabs of the plurality of electrode foils of a second polarity are connected to one another to form a second pole contact,
wherein the first pole contact is connected to the first enveloping metal sheet, which forms a first electrical pole of the single cell,
wherein the second pole contact is connected to the second enveloping metal sheet, which forms a second electrical pole of the single cell,
wherein the current discharge tabs of the first polarity are led out at a first pole side of the electrode foil stack and are connected to one another in a middle area of the first pole side to form the first electrical pole contact, and the first electrical pole contact is angled parallel to the first pole side and is connected to the first enveloping metal sheet, and
wherein the current discharge tabs of the second polarity are led out at a second pole side of the electrode foil stack and are connected to one another in a middle area of the second pole side to form the second electrical pole contact, and the second electrical pole contact is angled parallel to the second pole side and is connected to the second enveloping metal sheet.

20. The battery according to claim 19, wherein the the battery is a traction battery of an electric vehicle, a hybrid vehicle, or a vehicle operated with fuel cells.
